(19) United States
(12) Patent Application Publication
(10) Pub. No.: US 2011/0146037 A1
(43) Pub. Date: Jun. 23, 2011

(54) SEALED CREMATORY URN

(76) Inventor: Alfred J. Gomes, Reno, NV (US)

(21) Appl. No.: 12/642,235

(22) Filed: Dec. 18, 2009

(51) Int. Cl. A61G 17/08; B44C 5/04

(52) U.S. Cl. 27/1; 156/63

(57) ABSTRACT

A sealed crematory urn is disclosed that can be sealed internally and externally for moisture and built from a natural material that enables a side and face to be matched or front faces of multiple urns to be matched with the natural pattern of the material.

### BRIEF DESCRIPTION OF THE INVENTION

Sealed crematory urns are disclosed, including a crematory urn that can be sealed internally and externally for moisture and built from a natural material that enables a side and face to be matched or front faces of multiple urns to be matched with the natural pattern of the material.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Humans have cremated their dead for centuries, but modern societies have moved away from the utilization of the funeral pyre to more private, hygienic and less polluting crematoriums. Even when a body is cremated in a modern crematorium, the body is not entirely consumed by the fire, leaving the living to find a solution to dealing with the remaining ashes and bones.

For many years, the ashes and bones have been placed in urns made of wood, stone and other materials, but this presents some other problems as well. Urns made of stone have traditionally been urn shaped, that is, the urn has a small upper opening, a larger central area, and a smaller closed lower area that is designed to sit on a surface, leaving the urn standing upright. The small upper opening of urns are often too small to easily receive all of the remaining ashes and bones of the deceased, especially since many of the fragments of bones from the skull, arms, legs and hips can be too large to fit through the opening. As a result, it has been a common practice in the crematory industry to grind the remaining large bone fragments in a grinder, called an “electric cremated remains processor” or a “cremulator” that grinds the bones into the consistency of a powder or sand, before attempting to place the remains of the deceased in an urn. If this practice was generally made known to the relatives and friends of the deceased, there would be concerns about the mixing of ashes of one deceased with another in the grinder and religious concerns regarding treatment of the deceased.

As a result, a variety of solutions have been developed to prevent bones from being ground to fit into an urn. Urns have been made of different shapes and other materials than natural stone, but this has raised other issues. Box-type urns with removable lids make it easier to place the remains of the deceased in the urn, but raise concerns about how easily the lids may be removed, whether by accident or on purpose. Attempts to place the remains of the deceased in other types of containers have raised similar concerns regarding the security of the container as well as the sealing of the container from natural elements. Dried bone fragments and ashes easily absorb water, so urns placed in humid conditions can absorb water from the air and channel some amount of that water into the urn. Likewise, urns placed in the ground can easily take on water. Relatives and friends of the deceased tend to not be pleased with the thought of this, especially since many people opt to be cremated rather than buried because they do not like the idea of their remains being consumed by nature. For this reason, many people are buried in sealed coffins or are placed in above ground burial chambers.

For the same reason, many people who are cremated have their urns placed in above ground chambers. Since the Roman times, urns have been placed in niches within a tomb or columbarium. Modern buildings housing urns typically include many niches in which the urns are placed over which an engraved face is placed, sealing the urn within the niche. A more modern trend is to place a glass or clear plastic covering over the niche so the relatives and the friends of the deceased can see the urn for many years into the future when they come to mourn the deceased. For this reason, it has become important for the urns to be visually attractive, well sealed, and to provide the relatives and friends of the deceased with a high level of security and comfort. Crematory urns do not currently meet all of these needs.

### BRIEF DESCRIPTION OF THE SEVERAL VIEWS OF THE DRAWING

FIG. 1 is a top view of a tile in accordance with an embodiment;

FIG. 2 is a perspective view of an urn in accordance with an embodiment wherein one side and the front face are formed from the tile of FIG. 1;

FIG. 3 is a front view of two urns in accordance with an embodiment wherein the front faces of the urn are formed from the tile of FIG. 1;

FIG. 4 is a partially broken side view of the interior of an urn in accordance with an embodiment showing the lid being held in place by a tab affixed to the interior of the back face; and

FIG. 5 is a side view of the lid prior to installation.

### DETAILED DESCRIPTION OF THE INVENTION

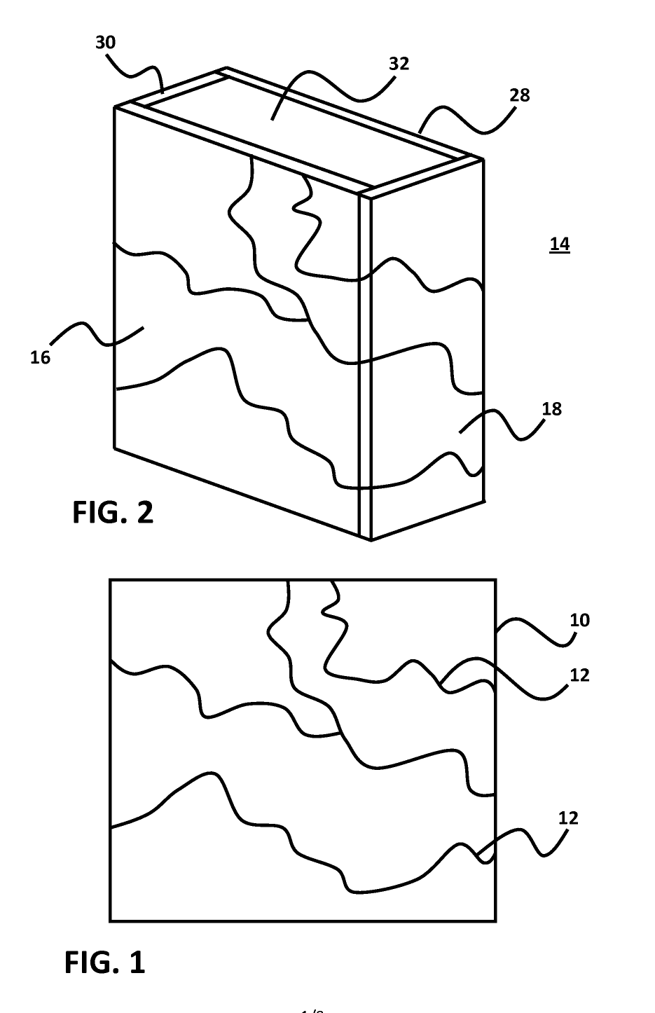

Sealed crematory urns are disclosed, including a crematory urn that can be sealed internally and externally for moisture and built from a natural material that enables a side and face to be matched or front faces of multiple urns to be matched with the natural pattern of the material. As illustrated in FIG. 1, the material to be used to form the urns can be a natural material 10 with a pattern 12 formed within the material 10 or an artificial material with a pattern formed within the material or applied to the surface of the material. Natural materials include onyx, granite, marble, quartz, coral and other common stones used as building materials and the like. Synthetic or artificial materials include ceramic tiles, plastic or synthetic tiles and similar sorts of materials.

FIG. 2 illustrates a completed urn 14 that is formed, in part, from the material 10 of FIG. 1, which is comprised of a number of panels or components. For example, if the material 10 of FIG. 1 is a 12 inch by 12 inch square or tile of material, of about ⅜ inches thick, the urn 14 can have one side panel, such as left side 16, and its front face panel 18 formed from the same material 10 to form an urn 14 that is approximately about 4 inches wide by about 7 inches deep by about 9 to about 12 inches tall. When the urn 14 is placed in a niche, it will be turned slightly so as to expose the side 16 and front face 18 to viewers. Although the other side panel and back face panel of the urn 14 are just as attractive as the side panel 16 and front face panel 18, the urn 14 is turned so as to better display the matching pattern 12 or grain running from the side panel 16 to the front face panel 18.

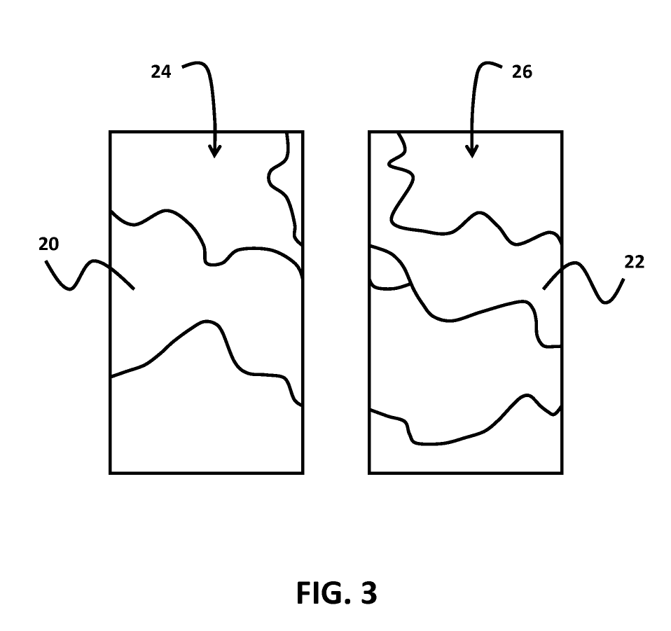

Other sizes of material 10 could also be used, such as an about 18 inch by about 18 inch tile, as well as other shaped tiles, so as to form the side and face, and perhaps another side out of the same tile, or to form multiple faces from the same piece of material. FIG. 3 illustrates the same piece of material 10 from FIG. 1 used to form the front face panels 20 and 22 of two separate urns 24 and 26, respectively. When two people are planning for their funeral arrangements, they may desire to purchase matching urns that share a piece of material 10 and can both be displayed side by side. When both urns 24 and 26 are placed in a niche, they would be placed close to one another so the pattern 12 on the front face panels 20 and 22 can be seen as running together. Alternatively, one urn could have a side and front face panel made of the same tile and the other urn could have just its face panel made of the same tile, so that the pattern on the side panel ran into the front face panel of the first urn and then into the front face panel of the second urn. As many as three front face panels could be cut from a single 12 by 12 tile, while four or more face panels could be cut from larger sized tiles. Multiple urns would also be positioned so as to highlight the matching patterns on the side/front face panels. Materials with highly distinctive and colorful patterns are preferred for their ability to showcase the pattern matching characteristics of an embodiment.

The process by which the urns are made begins with the selection of the material for matching the side/face/face panels that will maximize the individuality of single urns and the uniqueness of any matched urns. The other side, top, back and bottom panels would also typically be made of the same material and chosen to match with the pattern matched material as well as possible, although other materials could be used to create a less expensive urn. Once the layout of the material is determined, the material is cut to size for the different panels. As shown in FIG. 2, the front face panel 18 is cut to cover the entire front face of the urn, with an edge of side panel 16 and side panel 28 butting up against the back of the front face panel 18. The rear face panel 30 would then fit between side panel 16 and side panel 28. The top or lid panel 32 would be fit within the upper portions of the front face panel 18, side panels 16 and 28 and back face panel 30. The bottom panel would be fit within the lower portions of the same side and face panels.

Once the materials have been cut to form the side, face, lid and bottom panels, all of the material (if made of stone or other materials that hold water) would be heated to dry them as much as possible. Stone and natural materials can be heated with a torch or in an 80-90 degree heating room overnight. It is important to remove as much moisture from the materials as possible so the epoxy or adhesive used to bind the various pieces or panels together will bond with the material so as to improve the ability of the material 10 to seal. After the heating process, the urn 14 is assembled as cut using a liquid or paste-type epoxy that will penetrate into the material and ensure a durable hold between the pieces.

Alternatively, a number of different techniques could be used to build the urns. For example, a different adhesive other than epoxy could be used to bond the various pieces together, such as strips of adhesive tape and other types of natural or synthetic adhesives. The various panels of the urn could also be cut, such as in a tongue and groove configuration, to fit together tightly and then be sealed. Masonry screws could be used to hold the various panels together as well, although the smooth surfaces and connections between the panels would be lost, making this type of construction less attractive and desirable. Regardless of the manner in which the panels are bonded together (adhesed, fitted or mechanically adjoined), the joints will need to be well sealed, as further described below to prevent moisture from getting into the urn.

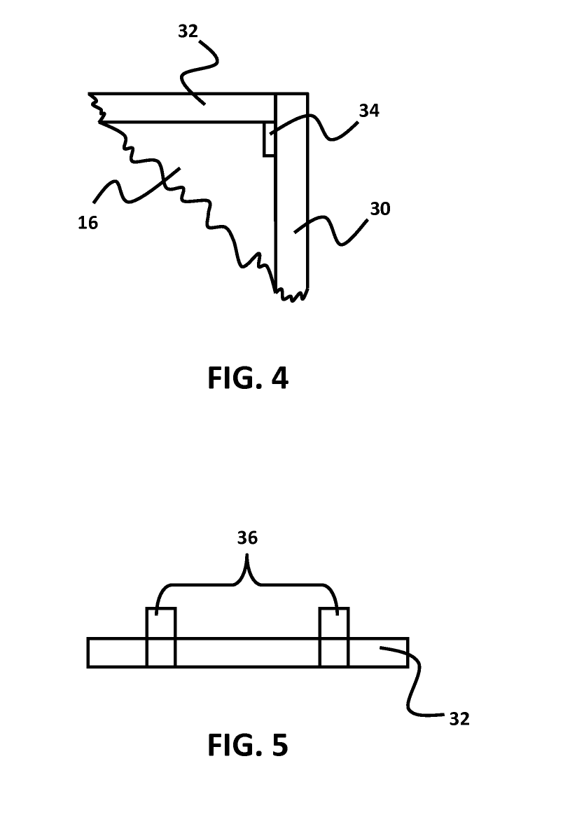

As illustrated in partially broken FIG. 4, one embodiment for installing the lid panel 32 is shown. Strip tabs 34 or some other form of a support are sized and adhered (with the epoxy) to the interior of the front face panel 18 and rear face panel 30 so as to hold the lid panel 32 in position. Strip tabs could also be adhered to the interior of the side panels 16 and 28, or smaller nubs could be added at appropriate places to hold the lid panel 32 in place. The tabs 34 could be installed prior to sealing the interior of the urn 14 or after it has been sealed.

The positioning of the tabs or nubs should be such that the exterior surface of the lid panel 32 is flush with the upper edges of the side panels 16 and 28, the front face panel 18, and the rear face panel 30. It is preferable that the lid panel 32 be cut to fit as tightly into the upper portion of the urn 14 as possible so that it will be difficult to remove in the future. Because the thickness of and the interior surface of the lid panel 32 may be irregular, the tabs 34 of nubs may have to be located in different positions for each urn 14. The bottom panel of the urn 14 would likewise be cut to fit within the bottom portion of the urn 14 as tightly as possible, and it would be glued or otherwise bonded in place with the epoxy or other techniques used to assemble the rest of the urn 14. Until the urn 14 is filled with remains, however, the lid panel 32 needs to be removable, so the lid might be cut slightly looser than the bottom panel so it can be removed, yet still tight enough to form a good seal, as further explained below.

Alternatively, a router could be used to create an edge on the inside of front face panel 18 and rear face panel 30 on which the lid panel 32 could rest in place of the tabs 34. Likewise, the side panels 16 and 28 could be routered on the top inside edge to further hold the lid panel 32, along with the front face panel 18 and rear face panel 30, or in place of the front face panel 18 and rear face panel 30.

After the epoxy or other bonding material holding the panels of the urn 14 together have set sufficiently to handle the urn 14 without fear of it falling apart, a clear (when dried) liquid epoxy or other extremely durable sealing compound is poured into the interior of the urn and spread over the entire interior (including the interior surface of the lid panel 32) to seal the interior from external moisture. The clear coating of the epoxy gives the interior of the urn 14 a wet or polished look even though the interior of the urn 14 is formed from the rough and unpolished side of the material 10. Each urn 14 can be tested after the interior epoxy has dried to test its seal by filling the urn 14 with water and monitoring to see if any water leaks out over time, or placing the urn 14 in a vat of water and monitoring to see if any water leaks in over time. If necessary, additional coatings can be applied. Naturally, other materials could be used on the interior of the urn 14 to provide a seal coating.

The exterior surfaces of the urn 14 are then polished, once the interior has completely dried, to give the sides, faces, lid and bottom panels a polished finished appearance. The polishing process also removes any excess epoxy that might have dried on the exterior surface from a sealed joint, fills any holes or irregularities in the exterior surfaces, and evens out any uneven joints. The urn 14 can be polished by hand, or by placing it within a frame or machine designed for polishing an object of this shape and size.

The polished urn 14 is then sealed with a stone impregnator, such as the HMK S31 silane impregnator or HMK S34 silicone impregnator manufactured by ACI International, which further seals the urn 14, causes it to repel water and makes it resistant to fingerprints from being handled. Once an urn 14 is interned in a niche, it is undesirable for fingerprints on the urn to be visible forever, and even though care is taken by most handlers, that is not always the case. Utilization of an appropriate impregnator helps to avoid this issue.

As illustrated in FIG. 5, the lid panel 32 of the finished urn 14 is affixed with a number of removable handles 36 that enable the lid panel 32 to be removed from the urn 14, so that remains may be placed inside the urn 14, and then have the lid panel 32 replaced without the handles 36. As previously noted, each lid panel 32 may be irregularly shaped and will be uniquely cut and positioned (by tabs 34) to fit each urn 14. As a result, it is preferable to use some form of alignment mechanism to align the lid properly within the upper opening, such as placing alignment dots on the lid and some portion of the remainder of the urn 14, so it will be possible for a handler to determine how the lid panel 32 should be placed once removed from urn 14. Once the remains have been added to the urn 14, the handler would place a bead of silicon caulking material, epoxy or similar material to the edges of the lid panel and/or the upper portion of the interior of the urn 14 to seal the lid panel 32 in place. The lid panel 32 would be properly aligned with the remainder of the urn 14, and the tape handles 36 would be removed, and the lid panel 32 would be placed in the upper portion of the urn. Any excess caulking or epoxy could then be wiped away and the caulk or epoxy would be allowed to dry before being further handled and interred within a niche.

While several embodiments have been disclosed, it is to be understood that the techniques described herein can have a multitude of additional uses and applications. Accordingly, the invention should not be limited to just the particular description and various drawing figures contained in this specification that merely illustrate an embodiment and application of the principles of the invention.

What is claimed is:

1. A crematory urn, comprising a set of panels, including a bottom panel, a first side panel, a second side panel, a rear panel, a front panel and a top panel, the set of panels being formed of a natural or synthetic material, each of the panels of the set of panels bonded to one or more other panels within the set of panels so as to form a closed urn having one or more interior surfaces, one or more exterior surfaces, and a removable top panel that fits within an upper opening formed by the first side panel, the second side panel, the rear panel and the front panel, the natural or synthetic material having a pattern visible on the one or more exterior surfaces, the front panel and at least the first side panel being arranged so the pattern visible on an exterior surface of the front panel matches the pattern visible on an exterior surface of the first side panel.

2. The urn as recited in claim 1, wherein the natural or synthetic material is selected from a group consisting of onyx, granite, marble, quartz, coral, common stone, ceramic tile and synthetic tile.

3. The urn as recited in claim 1, wherein the set of panels are bonded by an adhesive.

4. The urn as recited in claim 1, wherein the one or more interior surfaces are sealed to prevent liquid from entering the closed urn.

5. The urn as recited in claim 1, further comprising one or more removable handles affixed to the top panel so the top panel can be removed after the closed urn has been completed, remains can be placed within the closed urn, the one or more removable handles can be removed, and the top panel can be placed within the upper opening.

6. The urn as recited in claim 5, further comprising one or more supports adhered to the one or more interior surfaces for holding the top panel in place within the upper opening.

7. The urn as recited in claim 5, wherein an interior surface of two or more of the first side panel, the second side panel, the rear panel and the front panel are edged to support and hold the top panel within the upper opening.

8. The urn as recited in claim 5, further comprising an alignment mechanism for aligning the top panel within the upper opening once the top panel has been removed from the closed urn.

9. A series of crematory urns, comprising a set of panels for each urn among the series of crematory urns, including a bottom panel, a first side panel, a second side panel, a rear panel, a front panel and a top panel, the set of panels being formed of a natural or synthetic material, each of the panels of the set of panels bonded to one or more other panels within the set of panels for each urn so as to form a series of closed urns each having one or more interior surfaces, one or more exterior surfaces, and a removable top panel that fits within an upper opening formed by the first side panel, the second side panel, the rear panel and the front panel of each urn among the series of closed urns, the natural or synthetic material having a pattern visible on the one or more exterior surfaces, the front panel of each urn being arranged so the pattern visible on an exterior surface of the front panel of a first urn among the series of crematory urns matches the pattern visible on an exterior surface of the front panel on each remaining urn among the series of crematory urns.

10. The urn as recited in claim 9, wherein the natural or synthetic material is selected from a group consisting of onyx, granite, marble, quartz, coral, common stone, ceramic tile and synthetic tile.

11. The urn as recited in claim 9, wherein the set of panels are bonded by an adhesive.

12. The urn as recited in claim 9, wherein the one or more interior surfaces are sealed to prevent liquid from entering each of the closed urns among the series of closed urns.

13. The urn as recited in claim 9, further comprising one or more removable handles affixed to the top panel so the top panel can be removed after each closed urn among the series of closed urns has been completed, remains can be placed within each closed urn among the series of closed urns, the one or more removable handles can be removed, and the top panel can be placed within the upper opening.

14. The urn as recited in claim 13, further comprising an alignment mechanism for aligning the top panel with the upper opening once the top panel has been removed from each closed urn among the series of closed urns.

15. A method for manufacturing a crematory urn, comprising the steps of:
selecting a natural or synthetic material for forming a set of panels, including a bottom panel, a first side panel, a second side panel, a rear panel, a front panel and a top panel;
forming the first side panel and the front panel from a single piece of the natural or synthetic material so any pattern on or within the natural or synthetic material runs from the first side panel to the front panel;
bonding each panel from the set of panels to one or more other panels within the set of panels so as to form a closed urn having one or more interior surfaces, one or more exterior surfaces, and a removable top panel that fits within an upper opening formed by the first side panel, the second side panel, the rear panel and the front panel;
sealing the one or more interior surfaces of the closed urn;
affixing one or more removable handles to the top panel that can be used to remove the top panel when remains are to be placed within the closed urn and removed before sealing the closed urn; and
polishing the one or more exterior surfaces.

16. The method as recited in claim 15, further comprising the step of creating one or more supports on the one or more interior surfaces to support and hold the top panel within the upper opening.

17. The method as recited in claim 15, further comprising the step of sealing the one or more exterior surfaces.

18. The method as recited in claim 15, wherein the natural or synthetic material is selected from a group consisting of onyx, granite, marble, quartz, coral, common stone, ceramic tile and synthetic tile.

19. A method for manufacturing a series of matching crematory urns, comprising the steps of:
selecting a natural or synthetic material for forming a set of panels for each urn in the series of matching crematory urns, including a bottom panel, a first side panel, a second side panel, a rear panel, a front panel and a top panel;
forming the front panel of each urn among the series of matching crematory urns from a single piece of the natural or synthetic material so any pattern on or within the natural or synthetic material matches the front panel of each urn among the series of matching crematory urns;
bonding each panel from the set of panels to one or more other panels within the set of panels so as to form a series of closed urns each having one or more interior surfaces, one or more exterior surfaces, and a removable top panel that fits within an upper opening formed by the first side panel, the second side panel, the rear panel and the front panel of each closed urn among the series of closed urns;
sealing the one or more interior surfaces of each closed urn among the series of closed urns; and
affixing one or more removable handles to the top panel of each closed urn among the series of closed urns that can be used to remove the top panel when remains are to be placed within each closed urn among the series of closed urns and removed before sealing each closed urn among the series of closed urns.

20. The method as recited in claim 19, wherein the natural or synthetic material is selected from a group consisting of onyx, granite, marble, quartz, coral, common stone, ceramic tile and synthetic tile.
